(19) United States
(12) Patent Application Publication
(10) Pub. No.: US 2006/0059459 A1
(43) Pub. Date: Mar. 16, 2006

(54) Generating solution-based software documentation

(75) Inventor: Sean P. Grimaldi, Bellevue, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation, Redmond, WA (US)

(21) Appl. No.: 10/939,633

(22) Filed: Sep. 13, 2004

(51) Int. Cl. G06F 9/44

(52) U.S. Cl. 717/109

(57) ABSTRACT

A problem and a solution to the problem may be described via a language capable of representing structure and relationships. From the problem/solution description, solution-based documentation such as text, figures and code may be programmatically generated.

### FIELD OF THE INVENTION

The invention relates to programmatically generating software documentation and in particular to programmatically generating solution-based documentation.

### BACKGROUND OF THE INVENTION

Documentation is written or displayable information associated with computer software. Documentation may provide a technical description of the software, provided as an aid in the evaluation, installation, support, maintenance or future development of the software. This type of documentation typically includes information such as when, where, and by whom the software was written; a general description of the purpose of the software, including recommended input, output, and storage methods; and a detailed, although not necessarily comprehensive, description of the way the software functions. It may also include programming code, diagrams, and flow charts; and details of software testing, including sets of test data with expected results.

Documentation may also explain how to use the software. This type of documentation typically includes an explanation of the purpose of the software; instructions for running and using the software; instructions for preparing any necessary input data; instructions for requesting and interpreting output data; and explanations of any error messages that the program may produce.

Some compilers and other software development tools automatically create documentation. For example, the compiler for Microsoft C# and many object oriented programming language compilers can generate a listing of types, members, method signatures and so on. Frequently, this programmatically-produced documentation is augmented by a human technical writer who adds a text description, summary, etc. in an attempt to make the documentation more useful. One problem with such documentation is that the user of the documentation must have enough technical knowledge to generally know what has to be done. Armed with this general knowledge, the human-enhanced programmatically-produced documentation can be sufficient to inform the user how to accomplish the task.

Solution-based documentation is directed to solving particular problems. For example, while typical programmatically-produced documentation might describe the parts of a type, solution-based documentation might describe how types are meant to be used together to solve a problem. For example, instead of providing information concerning a Person type and an Event type, solution-based documentation might provide information about how to use a Person type and an Event type to invite people to a party. Although some solution-based documentation may be currently available, this type of documentation is typically not programmatically produced, and is very time-consuming and labor-intensive for humans to create. Furthermore, changes to the underlying programming (type definitions, etc.) must be manually applied to the solution-based documentation. Because of the nature of the life cycle of software, in which documentation is typically produced in a rush as the software is heading out the door, it would be helpful to have a documentation-generating tool that programmatically produces solution-based documentation, making it easier and faster to produce documentation and easier to keep the documentation current (in sync with) with the software it documents.

### SUMMARY OF THE INVENTION

A problem and/or a solution to the problem may be described via a language capable of representing structure and relationships. From the problem/solution description, solution-level documentation such as text, figures and code may be programmatically generated.

A problem and/or a solution to the problem may be described via any language capable of representing structure and relationships. A subset of suitable languages include languages capable of describing structure and relationships, such as C, Java, PL/SQL, HTML, ASN.1, XML as well as a wide range of syntaxes, such as Make, for example, and proprietary syntaxes and protocols. In some embodiments of the invention, the problem/solution is described in the language in accordance with a provided or user-defined schema.

A solution-based documentation generator may receive the problem/solution description, and programmatically produce therefrom a set of documentation. The documentation set may include one or more of a English prose text document or file, a diagram, figure, drawing or other pictorial or visual representation of the problem, and programming code to perform the task or action described. The English prose text may be a file or document or portion of a document describing the elements and relationships between elements of the problem, the steps to be performed to perform the action or task required to solve the problem, the location of elements required to perform the action or task, and other appropriate information. The diagram, figure or drawing may be a block diagram, graph, chart, flow diagram or flow chart or any suitable pictorial or visual representation of the elements and the relationships between elements of the problem and/or steps in the action(s) or task(s) associated with the solution to the problem, or other suitable information about the problem/solution.

The code may be code which when executed performs the task(s) or action(s) required to solve the problem. The code may be produced in any suitable programming language. An appropriate compiler may be called or accessed by the solution-based documentation generator to aid in the production of the code.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 is a block diagram of an exemplary system for generating solution-based documentation in accordance with one embodiment of the invention;

FIG. 3 is a flow diagram of an exemplary method for generating solution-based documentation in accordance with one embodiment of the invention;

FIGS. 4a-d is a exemplary input in accordance with one embodiment of the invention;

FIGS. 5a-c is an exemplary text output in accordance with one embodiment of the invention;

FIG. 6 is an exemplary figure output in accordance with one embodiment of the invention; and

FIG. 7 is a listing of an exemplary partial programming code output in accordance with one embodiment of the invention.

### DETAILED DESCRIPTION OF ILLUSTRATIVE EMBODIMENTS

Overview

A user may have difficulty using provided documentation on software to solve a problem because the user does not know how software elements relate. For example, the software documentation may include information on types Person and Event but may not include information about how to use types Person and Event to plan an event such as a conference, meeting or party.

In accordance with some embodiments of the invention, solution-based documentation might provide information about how to use the Person type and the Event type to invite people to a party. The problem and/or solution may be described via a language capable of representing structure and relationships. Suitable languages include meta languages such as XML, C, Java, PL/SQL, HTML, ASN.1, XML as well as a wide range of syntaxes, such as Make, for example, and proprietary syntaxes and protocols. In some embodiments of the invention, the problem and/or solution is described in the language in accordance with a provided or user-defined schema.

A problem-based documentation generator may receive the problem/solution description, and programmatically produce therefrom a set of documentation. The documentation set may include one or more of a English prose text document or file, a diagram, figure, drawing, flow chart or other pictorial or visual representation, and one or more code modules to perform the task or action required to solve the problem.

In some embodiments the English prose text may be a file or document describing the problem addressed, the elements and relationships between elements of the problem, the steps to be performed to perform the action or task required to solve the problem, the location of elements required to perform the action or task, and other appropriate information.

The diagram, figure or drawing may be a block diagram, graph, chart, flow diagram or flow chart or any suitable pictorial or visual representation of the elements, the relationships between elements of the problem/solution, the steps required to perform the task or action required to solve the problem, and so on.

The code may be code which when executed performs the task or action required to solve the problem. The code may be produced in any suitable programming language. In some embodiments of the invention, an appropriate compiler is accessed by the solution-based documentation generator to aid in the production of the code.

Exemplary Computing Environment

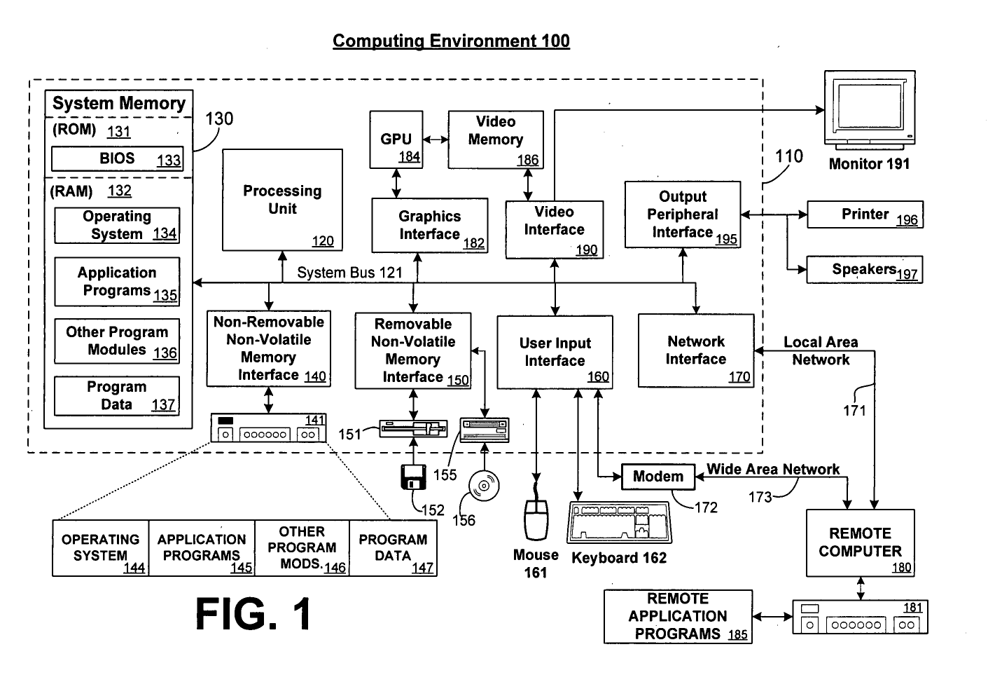

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

Programmatically Generating Problem-Based Documentation

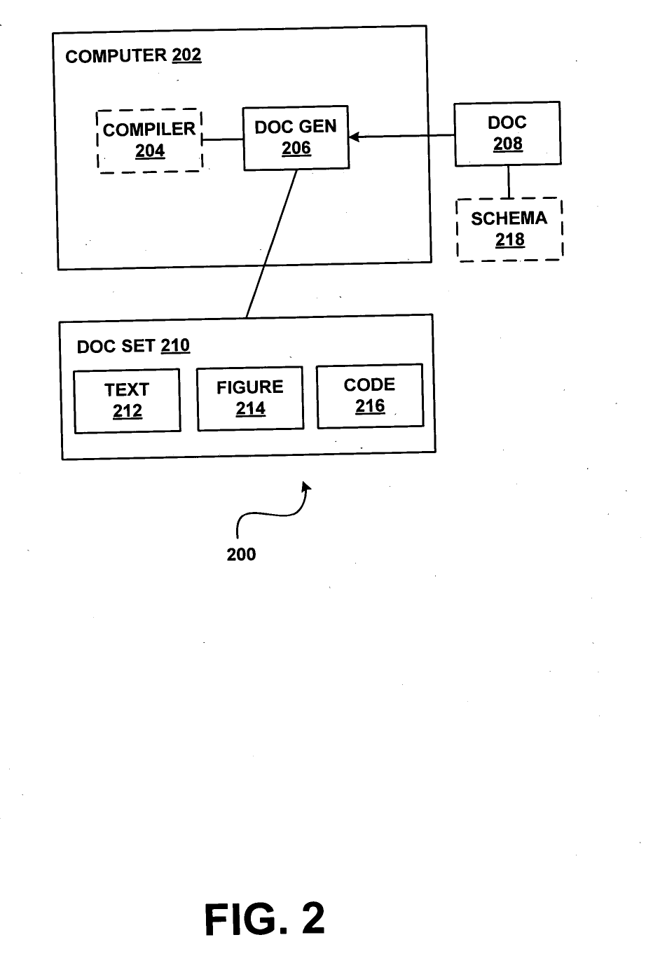

FIG. 2 is a block diagram of a system for generating solution-based documentation in accordance with one embodiment of the invention. In FIG. 2 a system for generating solution-based documentation 200 may reside on one or more computers such as computer 110 described with respect to FIG. 1.

System 200 may include one or more of a solution-based documentation generator 206, a compiler 204, input to the solution-based documentation generator 208, here represented as document 208, a schema 218 for the document 208 and output from the solution-based documentation generator 206, here represented as document set 210. In some embodiments of the invention, document set 210 may include one or more of: a text file or document 212, a figure or FIGS. 214, and programming code 216 to perform the task(s) or action(s) described by the input document 208.

The solution-based documentation generator 206 may receive as input a file or document 208 from which the documentation set 210 is generated. Document 208 may be written in a language such as XML, C, Java, PL/SQL, HTML, ASN.1, XML as well as a wide range of syntaxes, such as Make, for example, and proprietary syntaxes and protocols, or in any language capable of expressing structure and relationships. Document 208 may be written in accordance with a schema 218. Document 208 may describe a problem and/or a solution which addresses or solves a problem by performing a suitable action or task.

Document 208 in some embodiments of the invention includes one or more of: a problem and/or solution name, a description of the problem and/or a solution to the problem, a location at which elements referenced in the documents may be found, one or more elements or types used or addressed in the problem and/or solution, relationships between the elements or types, population of sample data, steps to perform the task and removal of sample data.

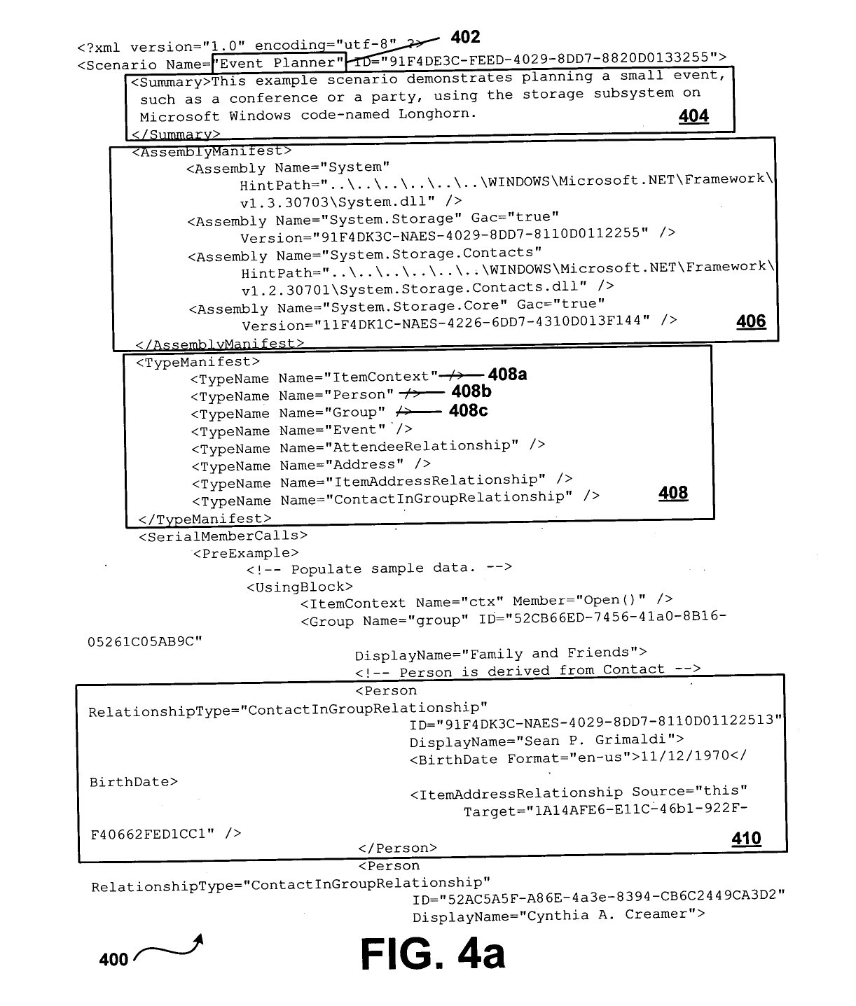

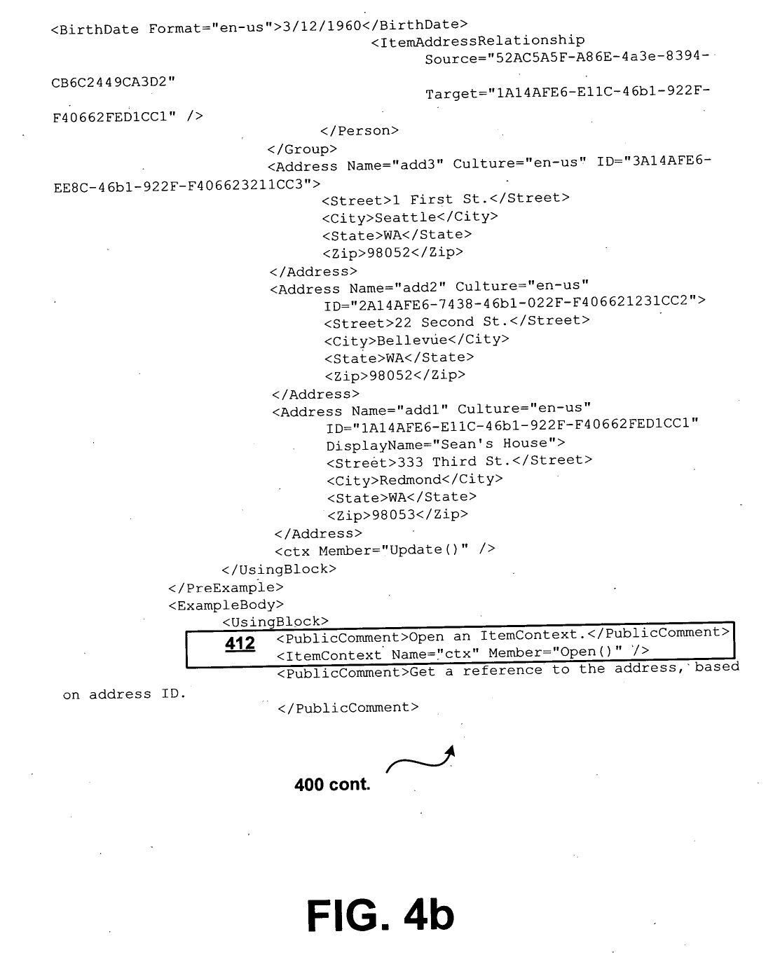

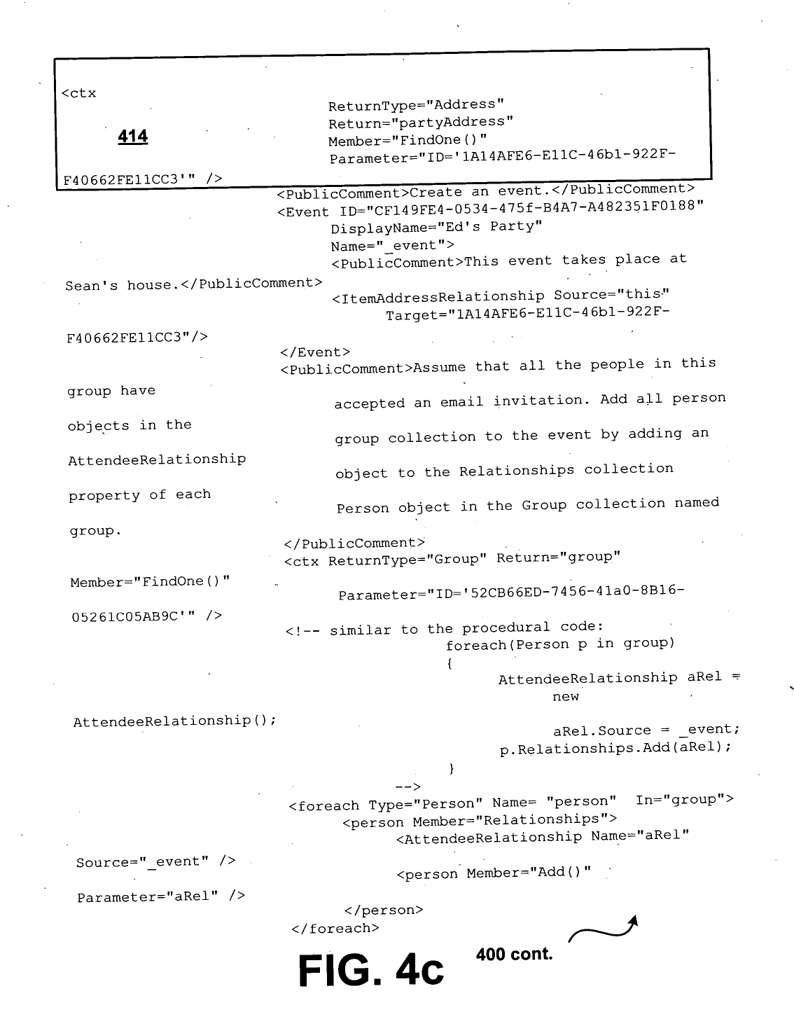

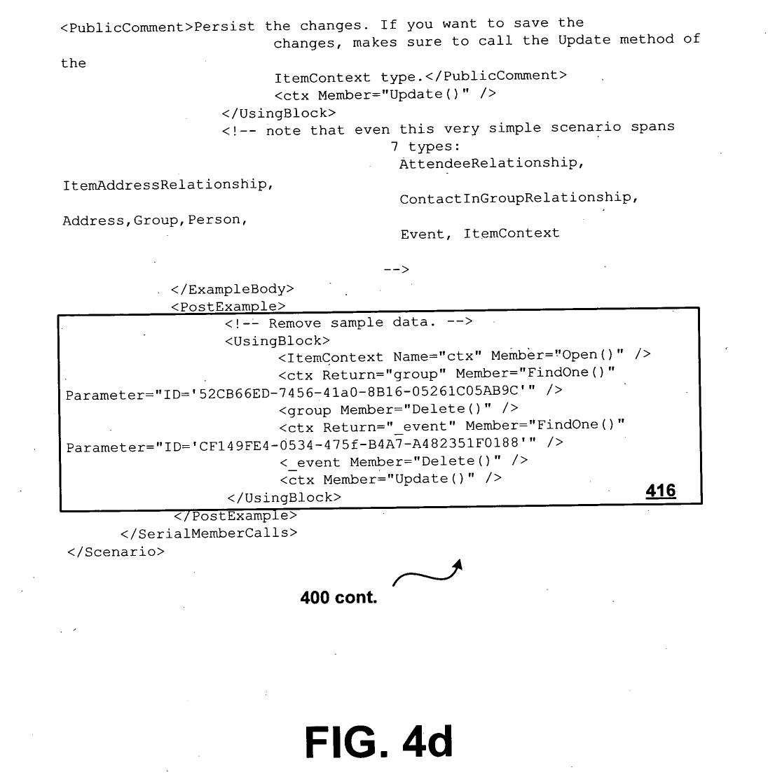

FIGS. 4a-4d illustrate an exemplary input document 400. For example, in FIG. 4a, exemplary document 400 includes a name 402, a description of the problem/solution 404, a list or manifest of locations at which elements referenced in the document may be found 406, a list of types referenced in the document, 408 including types ItemContext 408a, Person 408b, Group 408c, etc. In some embodiments of the invention, sample data may be populated as illustrated in FIG. 4a for Person Type “Sean P. Grimaldi” 410 and so on.

One or more steps may be described or defined in the document 208, as illustrated by exemplary step “Open an ItemContext” 412 in FIG. 4b for exemplary document 400. The second step is to get a reference to the address, based on the address identification code, as illustrated in FIG. 4c, block 414, and so on. In some embodiments of the invention, sample data may be removed as illustrated in FIG. 4d of document 400, block 416.

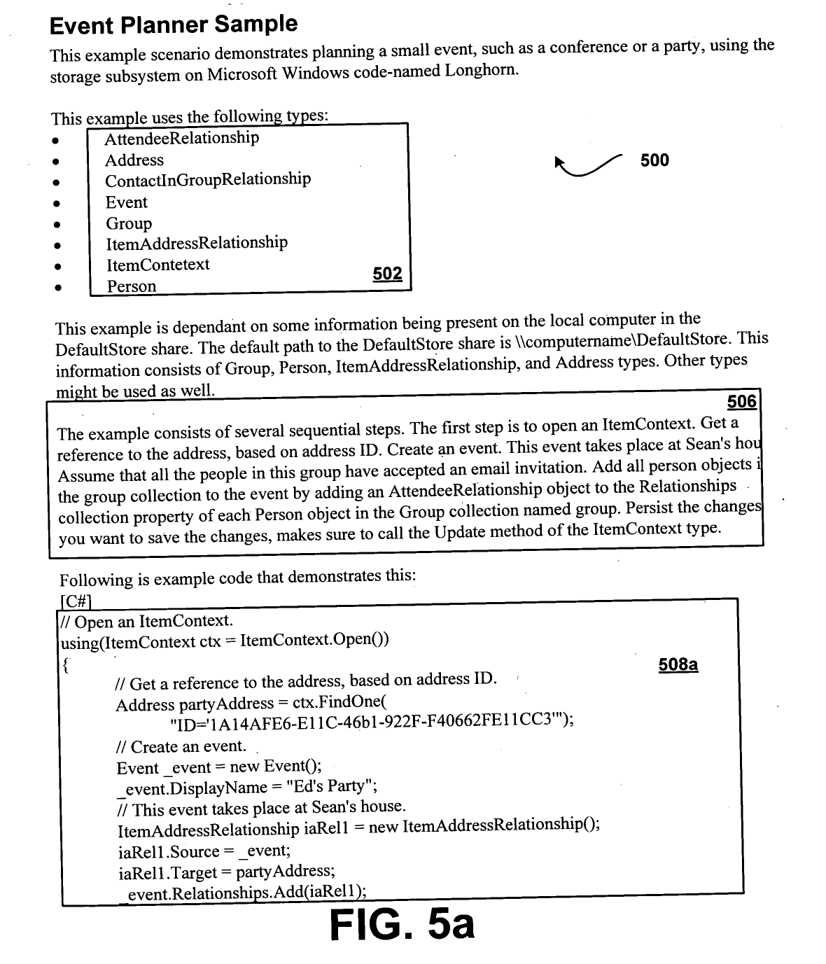

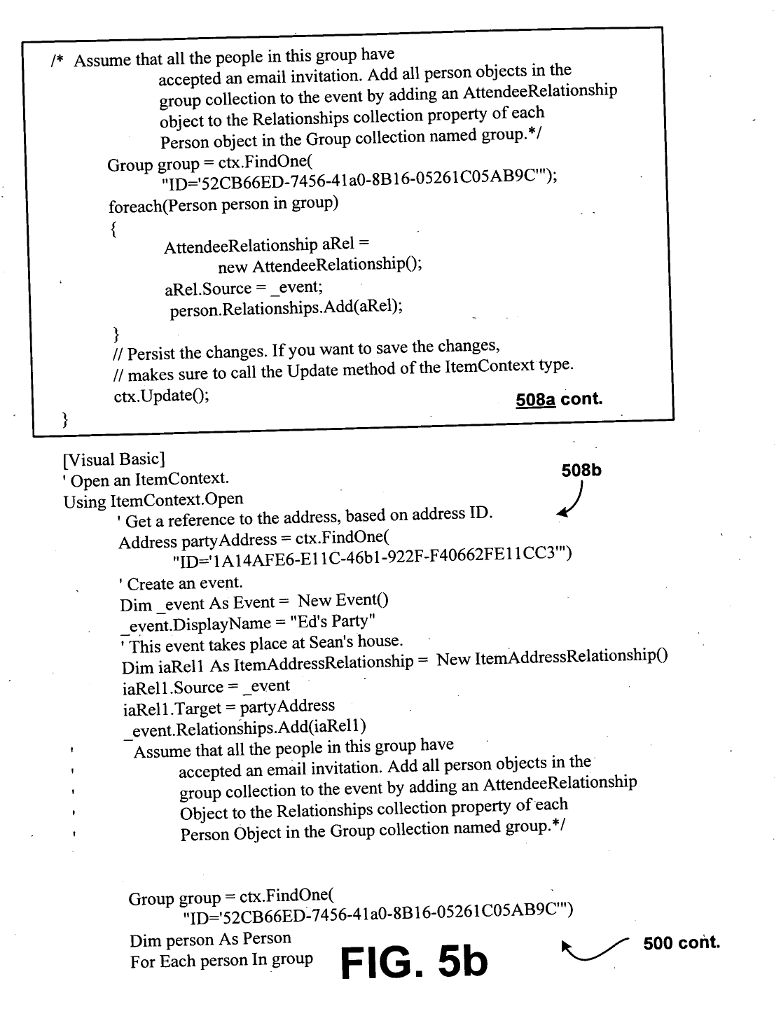

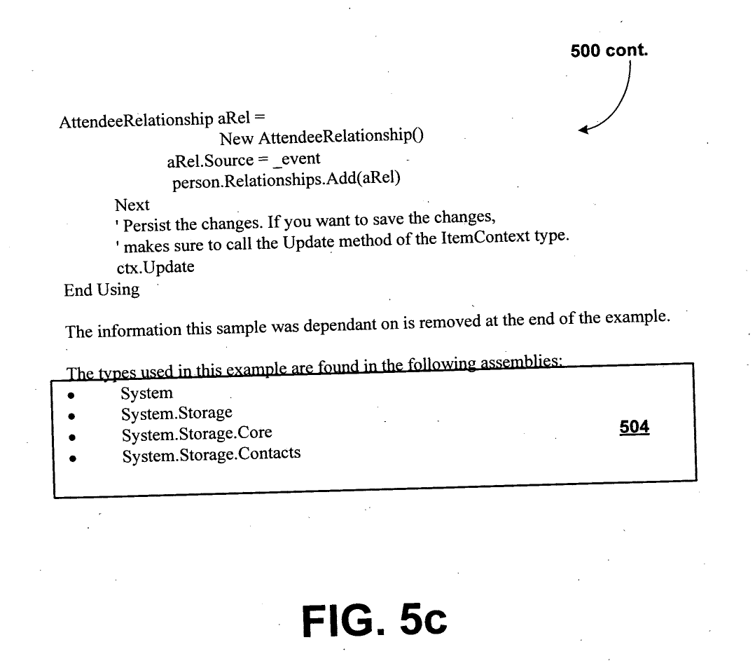

In some embodiments of the invention, solution-based documentation generator 206 generates a document set 210 from input 208. Document set 210 may include one or more of a text document or file 212, a FIG. 214 and code 216. A text document or file 212 may include information such as but not limited to a list of types, location information, information about steps in the task, example code and other useful information. In some embodiments of the invention, text document 212 is presented in English prose. An exemplary text document 500 is illustrated in FIGS. 5a-c. Exemplary text document 500 may include a list of one or more types 502 (FIG. 5a), location information 504 (FIG. 5c), information concerning steps to perform the task 506 (FIG. 5a) and example code 508a (FIG. 5a) and 508b (FIG. 5b). In text document 500 code is presented in C# (block 508a) and Visual Basic (block 508b) but it will be understood that the invention is not so limited, that is, code could be presented in any suitable programming language.

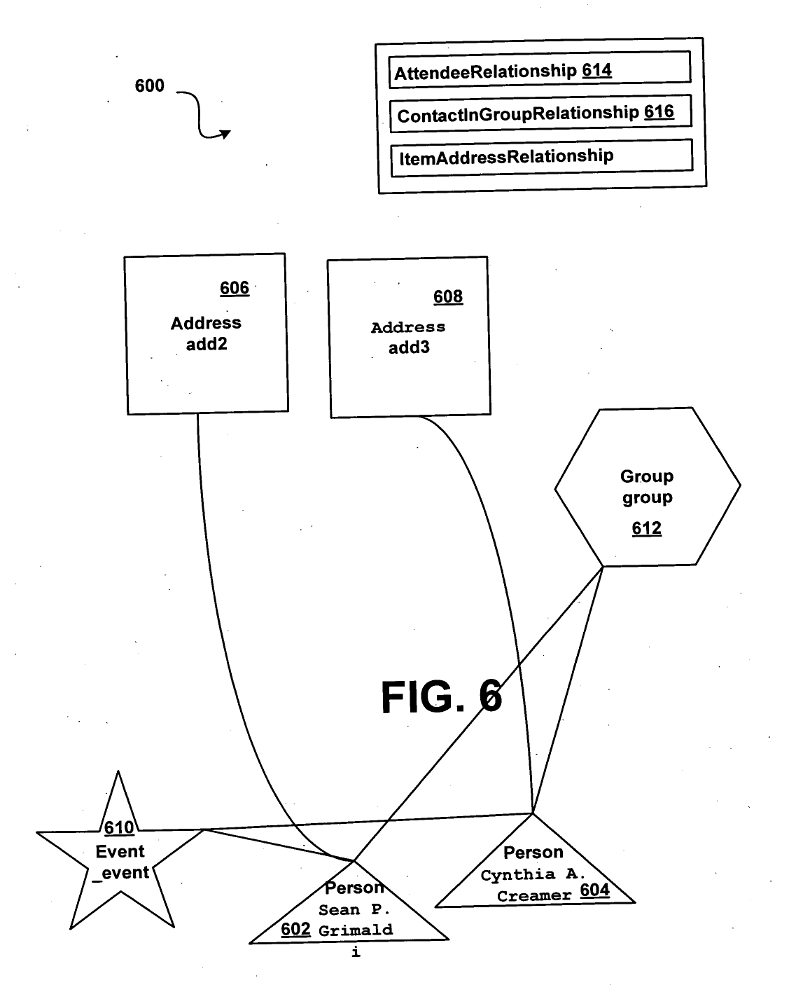

In some embodiments of the invention, problem-based documentation generator 206 generates a figure, drawing, graph, flow chart, flow diagram, state diagram or other pictorial or visual representation of the problem and its solution 214. An exemplary figure is represented in FIG. 6 by block diagram 600. Types (as illustrated by instances of Person type 602, 604, 606, 608, 610, and 612), and relationships between types as defined by the values for relationship properties for the types as illustrated by relationships 614 and 616 etc. may be illustrated. Steps to perform a task or actions required by the problem may also be displayed (not shown).

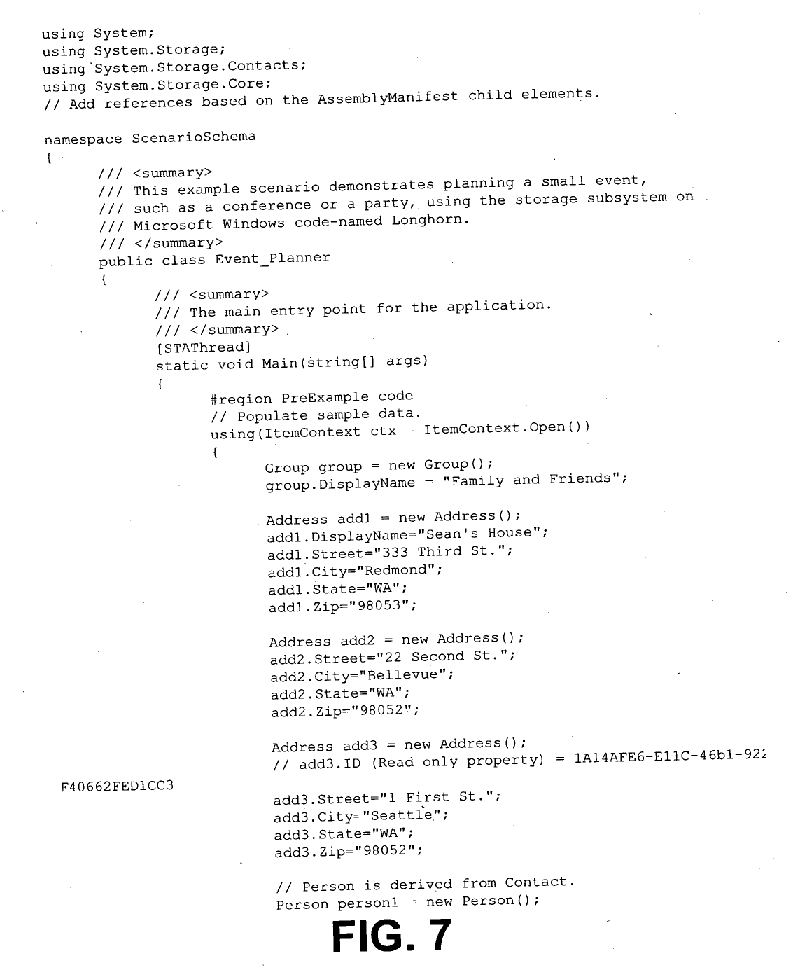

In some embodiments of the invention, solution-based documentation generator 206 may also generate program code. Exemplary code is illustrated in FIG. 7 (partial listing). The code in FIG. 7 is C# although it will be appreciated that any language code may be generated. In some embodiments of the invention, a compiler 204 for the language to be generated may be used to help in the generation or error checking of the code.

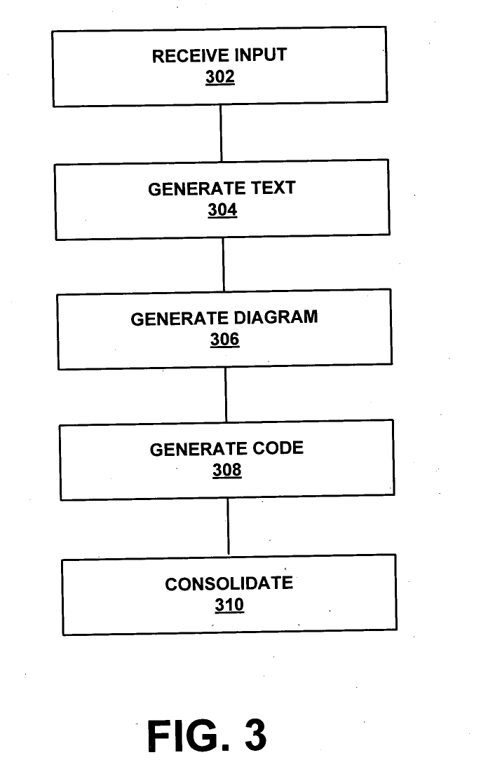

FIG. 3 is a flow diagram of an exemplary method for generating solution-based documentation. At step 302 the problem based documentation generator may receive the problem/solution description input. The input may include a definition of types and relationships between types, steps to perform a task or action required by the problem, and other suitable information as described above.

At step 304 a text document may be generated. The text document in some embodiments of the invention is an English prose document or file and may include information such as a listing of types, relationships between types, code or perform a task associated with the problem and so on as described above.

At step 306, a diagram, figure, drawing, graph, flow chart or other pictorial or visual representation of the problem may be generated. The diagram, etc. may include a representation of elements or types, relationships between the elements or types and other information as described above.

At step 308 code may be generated in any suitable language. An appropriate compiler may be called or accessed to aid in the generation of the code.

In some embodiments of the invention, a solution-based documentation generator as described above produces the text, diagram and/or code.

At step 310 the text, diagram and/or code may be incorporated into a single document set.

Steps 304, 306, 308 and 310 are optional. Steps 304, 306, and 308 may occur in any order.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed is:

1. A system for programmatically generating solution-based documentation comprising:
a solution-based documentation generator that receives an input, the input comprising a description of a problem and a solution to the problem and generates from the description of the problem and the solution to the problem, a text document, the text document describing the problem and the solution to the problem in English prose, program code to perform a task described in the input and a pictorial representation of the problem.

2. The system of claim 1, wherein the input is received in a meta language.

3. The system of claim 1, wherein the input comprises XML.

4. The system of claim 1, wherein the input complies with a schema.

5. The system of claim 4, wherein the schema is provided with the solution-based documentation generator.

6. The system of claim 1, wherein the text document comprises a list of elements associated with the problem and the solution to the problem.

7. The system of claim 1, wherein the text document comprises a relationship between a plurality of elements associated with the problem and the solution to the problem.

8. The system of claim 1, wherein the text document comprises a location of an element referenced by the input.

9. The system of claim 1, wherein the pictorial representation comprises a diagram illustrating a plurality of elements of the problem and the solution to the problem and a plurality of relationships between the plurality of elements of the problem and the solution to the problem.

10. The system of claim 1, wherein the pictorial representation comprises a flow chart.

11. The system of claim 1, wherein the program code comprises C# code.

12. The system of claim 1, wherein the program code comprises Visual Basic code.

13. A method of programmatically generating problem-based documentation comprising:
receiving a description of a problem and a solution to the problem in a language that represents a plurality of elements associated with the problem or the solution to the problem and a relationship between the plurality of elements:
generating from the description of the problem and the solution to the problem a text document, the text document comprising English prose describing the problem or the solution;
generating from the description of the problem and the solution to the problem a pictorial representation of the plurality of elements and the relationship between the plurality of elements; and
generating from the description of the problem and the solution to the problem program code for executing a task associated with solving the problem.

14. The method of claim 13, further comprising consolidating the text document the pictorial representation and the program code into a solution-based document set.

15. The method of claim 13, wherein the language is a meta language.

16. The method of claim 13, wherein the language is XML.

17. The method of claim 13, wherein the description of the problem and the solution to the problem complies with a schema.

18. The method of claim 17, wherein the schema is user-created.

19. The method of claim 13, wherein the text document describes a plurality of elements associated with the problem or the solution and a relationship between the plurality of elements.

20. The method of claim 13, wherein the text document describes a location of the plurality of elements.

21. The method of claim 13, wherein the pictorial representation comprises a graph.

22. The method of claim 13, wherein the pictorial representation comprises a flow diagram.

23. The method of claim 13, wherein the pictorial representation comprises a diagram.

24. The method of claim 13, wherein the pictorial representation illustrates a plurality of elements associated with the problem and the solution and a relationship between the plurality of elements.

25. The method of claim 13, wherein the program code comprises C# code.

26. A computer-readable medium comprising computer-executable instructions for:
receiving a description of a problem and a solution to the problem in a language that represents a plurality of elements associated with the problem or the solution to the problem and a relationship between the plurality of elements:
generating from the description a text document, the text document comprising English prose associated with the problem or the solution to the problem;
generating from the description a pictorial representation of the plurality of elements and the relationship between the plurality of elements; and
generating from the description program code for executing a task associated with the solution to the problem.

27. The computer-readable medium of claim 26, comprising further computer-executable instructions for:
consolidating the text document the pictorial representation and the program code into a problem-based document set.
